(19) United States
(12) Patent Application Publication
(10) Pub. No.: US 2007/0045082 A1
(43) Pub. Date: Mar. 1, 2007

(54) Passenger conveyor

(75) Inventors: Yoshinobu Ishikawa, Tokyo (JP); Yoshio Ogimura, Tokyo (JP); Shin Muakami, Tokyo (JP); Kazuhisa Hara, Tokyo (JP); Takashi Niino, Tokyo (JP); Tsutomu Ootsuki, Tokyo (JP); Takayuki Kikuchi, Hyogo-ken (JP); Yasuhiro Matsumoto, Saitama-ken (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Toshiba Elevator Kabushiki Kaisha, Tokyo (JP)

(21) Appl. No.: 10/548,072

(22) PCT Filed: Mar. 5, 2004
(86) PCT No.: PCT/JP04/02835

§ 371 Date: Oct. 3, 2006

(30) Foreign Application Priority Data
Mar. 7, 2003 (JP) 2003-062032

(51) Int. Cl. B66B 23/02

(52) U.S. Cl. 198/330

(57) ABSTRACT

Handrail drive belts (20A, 20B, 20C, 120A, 120B) are respectively driven in circulatory fashion within a railing (5) by drive force respectively extracted from step sprocket gears (2a, 2b) and a step chain. The handrail drive belts (20A, 20B, 20C, 120A, 120B) transmit drive force to a handrail belt (10, 110) by contacting the inner peripheral surface of the handrail belt (10, 110) at respectively different locations. In this way, the load on the handrail belt in a passenger conveyor of long travel is reduced.

### TECHNICAL FIELD

The present invention relates to passenger conveyors called escalators and moving walkways, and in particular relates to a handrail belt drive mechanism.

### TECHNICAL BACKGROUND

In recent years, in railway station buildings etc, escalators in which there is a large difference in levels of the upper-level and lower-level passenger ascending/descending entrances/exits (doorways) i.e. which have a large lift are common. In such escalators, when a step chain is driven solely by a step sprocket gear provided in the return region of the step chain, sometimes smooth drive of the steps cannot be achieved. The same problem exists in moving walkways with a long travel. In order to solve this problem, an escalator has been proposed in which an auxiliary step chain and drive mechanism is provided in a zone where the steps run in inclined fashion. One such escalator is disclosed in Laid-open International Patent Application No. WO00/63104, which relates to an international patent application by the present inventors.

The same problem exists regarding the handrail belt. However, the drive device of the handrail belt still follows the conventional construction, in which the handrail belt is sandwiched by a drive roller and a pressing roller provided opposite thereto and drive force is applied to the handrail belt by means of the frictional force acting between the handrail belt and the drive roller. Indeed, if the pressing force applied by the pressing roller is increased, the drive force applied to the handrail belt is increased, but there is the problem that if excessive tension or compressive force is applied to the handrail belt the life of the handrail belt is shortened.

Also, in recent years, a so-called intermediate acceleration type passenger conveyor has been proposed, in which the speed in the vicinity of the ascending/descending entrances/exits is low, while the speed in the intermediate region is high (see for example pages 45-48 of Collected Lectures of the Advanced Technology Lecture Association and Recent Techniques in Elevators and Amusement Equipment, the Japan Society of Mechanical Engineering (or Mechanical Association of Japan) [No. 01-58]). However, it appears that, even in such an intermediate acceleration type passenger conveyor, a handrail belt of fixed speed or a plurality of handrail belts whose speed changes in discontinuous fashion are employed. The use of such handrail belts poses problems regarding passenger safety.

The present invention was achieved in view of the above circumstances, its object being to provide a passenger conveyor comprising a handrail belt drive device whereby the load on the handrail belt can be reduced.

A further object of the present invention is to provide a passenger conveyor comprising a handrail belt drive device whereby load on the handrail belt can be reduced, even in the case of an escalator of high lift or a moving walkway of long moving distance.

Yet a further object of the present invention is to provide a passenger conveyor comprising a handrail belt drive device capable of being applied to a passenger conveyor of the so-called intermediate acceleration type wherein intermediate acceleration can be applied to the handrail belt also.

### DISCLOSURE OF THE INVENTION

In order to achieve the above object, a passenger conveyor according to the present invention comprises:

a plurality of steps that are moved in circulatory fashion, being linked in endless fashion;

a step drive mechanism that drives the plurality of steps;

a railing provided at the side of the steps;

a handrail belt that moves in circulatory fashion in a prescribed circulatory path wound onto the railing;

a handrail drive belt that moves in circulatory fashion in a prescribed circulatory path and that transmits drive force for moving the handrail belt in circulatory fashion to the handrail belt by contacting an inner peripheral surface of the handrail belt; and

a drive belt drive mechanism that drives this handrail drive belt.

A plurality of handrail drive belts may be provided. In this case, the plurality of handrail drive belts may drive the handrail belt by contacting the handrail belt in mutually different respective regions in the circulatory path of the handrail belt.

Suitably, the drive belt drive mechanism is constructed so as to extract drive force for driving the handrail drive belt from a member comprising a step drive mechanism. In this case, the member comprising the step drive mechanism whereby drive force is extracted may include a step chain, step sprocket gear (shaft of a step sprocket gear) a motor (output shaft of a motor) etc.

Preferably the handrail drive belt is in contact with the handrail belt and transmits drive force thereto at least in a range of the circulatory path of the handrail belt in which a passenger can touch the handrail belt.

Preferably means is provided to improve the meshing efficiency between the handrail drive belt and the handrail belt.

A plurality of handrail drive belts may be provided and a plurality of said drive belt drive mechanisms corresponding thereto may be provided, a first drive belt drive mechanism that drives a first handrail drive belt and a second drive belt drive mechanism that drives a second handrail drive belt, of this plurality of handrail drive belts, being provided, the second drive belt drive mechanism being arranged to be capable of driving the second drive belt with a speed that is greater than the speed with which the first drive belt is driven by the first drive belt drive mechanism. In this case, the handrail belt is made capable of extension/contraction in the length direction thereof. In this way, the speed of the handrail belt can be varied.

In this case, there may be provided at least one further roller that applies drive force by contacting the handrail belt, between a zone where the first handrail drive belt makes contact with the handrail belt and a zone where the second handrail drive belt makes contact with the handrail belt. In this case, the peripheral speed of the roller is made greater than the speed of the first handrail belt and less than the speed of the second handrail belt. Preferably, a plurality of rollers are provided and the peripheral speed of each roller is set so that the nearer the rollers are to the second handrail drive belt, the greater is their peripheral speed. The drive force for rotating the rollers can be extracted from the first handrail drive belt or the second handrail drive belt.

Also, the first handrail drive belt may be colored with a first color and the second handrail drive belt colored with a second color and at least one roller may be colored with a color that is intermediate between the first color and the second color. In this case, the handrail belt may be partially or wholly transparent or semi-transparent so that a passenger can visually recognize the first and second handrail drive belts and the at least one roller. If a plurality of rollers are provided, the peripheral speed of the rollers may be made greater, the nearer the rollers are to the second handrail drive belt; in this case, the coloring may be arranged to change from a color close to the first color to a color close to the second color as the second handrail drive belt is approached from the first handrail drive belt.

### BRIEF DESCRIPTION OF THE DRAWINGS

FIG. 1 is a diagrammatic side view showing major parts of a first embodiment of a passenger conveyor according to the present invention;

FIG. 2 is a diagrammatic side view showing the construction of major parts of a first drive belt drive mechanism;

FIG. 3 is a diagrammatic perspective view showing the construction of major parts of a second drive belt drive mechanism;

FIG. 4 is a partially broken away perspective view showing the construction of a region concerned with drive transmission from a drive belt to a handrail belt;

FIG. 5 is a diagrammatic side view showing major parts of a second embodiment of a passenger conveyor according to the present invention;

FIG. 6 is a partially broken away perspective view showing the construction and arrangement of a region concerned with drive transmission from a drive belt to a handrail belt and with speed changing means;

FIG. 7 is a diagrammatic side view showing the construction and arrangement of speed changing means; and

FIG. 8A is a diagram showing a condition in which rated load (ordinary load) is applied to the drive belt and the handrail belt and FIG. 8B is a diagram showing a condition in which more than rated load (excess load) is applied to the drive belt and the handrail belt.

### BEST MODE FOR PUTTING THE INVENTION INTO EFFECT

Embodiments of a passenger conveyor according to the present invention are described below with reference to the drawings.

### First Embodiment

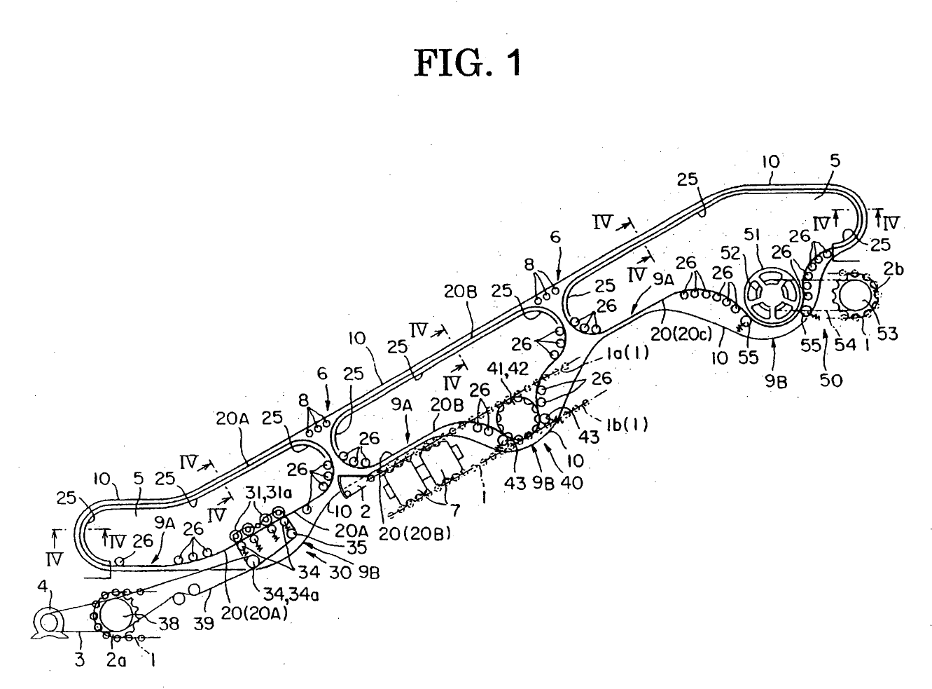

First of all, a first embodiment is described with reference to FIG. 1 to FIG. 4. As shown in FIG. 1, which is a side view showing major parts of a passenger conveyor according to the present invention, a passenger conveyor comprises a plurality of steps 2 (one only shown in FIG. 1) that are linked in endless fashion by means of a step chain 1. The step chain 1 runs between step sprocket gears 2a, 2b that are respectively provided below the entrance/exit of the upper and lower levels. The step sprocket gear 2a on the lower level is driven by a motor 4 (fitted with a gearbox (or reduction gears)) by means of a drive chain 3.

A guide rail (not shown in FIG. 1) that guides the step chain 1 is provided on the main frame, not shown. When the motor 4 is driven, the steps 2 execute circulatory movement between the upper and lower level along a prescribed circulatory track, defined by the step sprocket gears 2a, 2b and a guide rail etc for the step chain, not shown. Railings 5 are provided on both sides of the steps 2, which are arranged to constitute a stairway. An endless handrail belt 10 is provided on the railings 5 so as to move along a prescribed circulatory path along the railings 5.

The handrail belt 10 is driven by three endless handrail drive belts (hereinbelow, simply referred to as “drive belts”) 20 (20A, 20B, 20C). The drive belts 20 are guided so as to move along prescribed circulatory paths provided on the upper surface of the railings 5 and the interior of the railings 5 (in addition, depending on the case, within the main frame, not shown, below the railings 5) by means of guide rails 25 and guide rollers 26 etc provided on the railings 5. In the illustrated embodiment, a guide rail 25 is provided on the upper surface and in the interior of the railing 5 and guide rollers 26 are arranged in the interior of the railings 5 and within the main frame, not shown. The guide means (guide unit) of the drive belts 20 includes tensioners (not shown) that apply suitable tension to the drive belts 20.

The drive belts 20 are arranged so as to contact the handrail belt 10 at at least part of the respective circulatory paths, drive force transmission being effected from the drive belts 20 to the handrail belt 10 at these contacting parts. In the embodiment shown in FIG. 1, the drive belts 20 are arranged to contact the handrail belt 10 in a range, of the circulatory path of the handrail belt 10 where the handrail belt 10 can be touched by a passenger. Also, transmission of drive force from the drive belts 20 to the handrail belt 10 may be effected in a zone 9A where the drive belt 20 is adjacent to the handrail belt 10, in the return path region of the handrail belt 10.

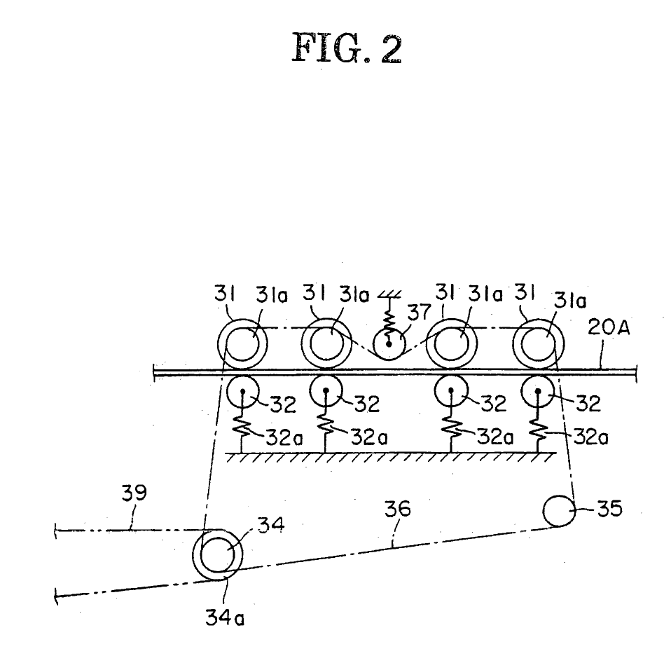

The first drive belt 20A provided on the lower level is driven by means of a first drive belt drive mechanism 30 (hereinbelow referred to as the “first drive mechanism 30”. In particular, as shown in detail in FIG. 2, the first drive mechanism 30 comprises a plurality of drive rollers 31 and pressing rollers 32. The first drive belt 20A is sandwiched by a drive roller 31 and pressing roller 32 in part of this circulatory track. The pressing roller 32 is pressed against the drive roller 31 that faces the drive belt 20A, by the resilient force of a spring 32 that is additionally provided. Reliable drive transmission from the drive roller 31 to the first drive belt 20A is thereby achieved.

Each drive roller 31 is additionally provided with a sprocket gear 31a that is coaxial therewith. A chain 36 spans this sprocket gear 31a and sprocket gears 34, 35. A sprocket gear 37 applies tensile force (tension) to the chain 36. As shown in FIG. 1 and FIG. 2, a timing pulley 34a coaxial therewith is additionally provided on the sprocket gear 34. The step sprocket gear 2a is additionally provided with a timing pulley 38 (see FIG. 1) that is coaxial therewith. A timing belt 39 spans the timing pulley 34a and timing pulley 38.

Consequently, when the step sprocket gear 2a is driven by the motor 4, simultaneously with this, the drive belt 20A is driven. The diameter of the wheels such as drive rollers, sprocket gears and the timing pulley is set such that the speed of movement of the drive belt 20A is equal to the speed of movement of the steps 2.

The chain 36 and the timing belt 39 could be endless motive force transmission members of other form such as for example a timing belt and chain; in this case, the sprocket gears and the timing pulleys are replaced by timing pulleys and sprocket gears matching these endless motive force transmission members.

Consequently, when the steps 2 are driven by the motor 4, the first drive mechanism 30 drives the first drive belt 20A by extracting motive force (motive power) from a shaft of the step sprocket gear 2a and the handrail belt 10 that contacts the first drive belt 20A is thereby driven. The construction of the regions where drive force transmission is effected from the drive belts 20 (20A, 20B, 20C) to the handrail belt 10 will be described later.

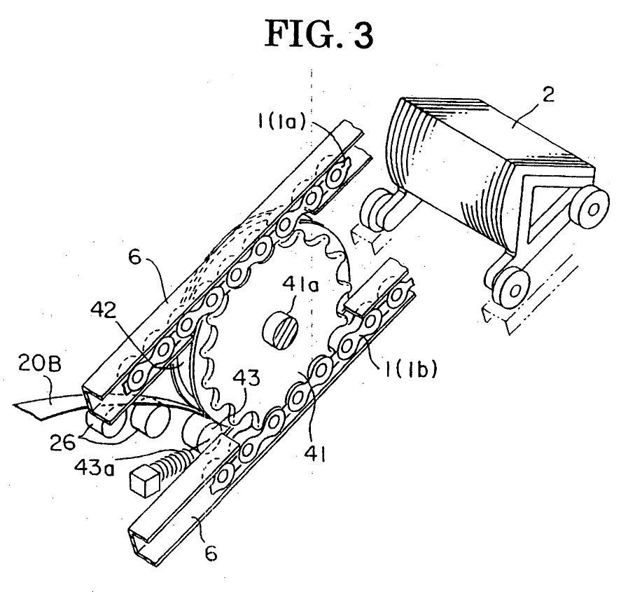

Next, the second drive belt drive mechanism 40 for the second drive belt 20 provided in the middle (hereinbelow referred to as the “second drive mechanism 40”) will be described with reference to FIG. 1 and FIG. 3. The construction of the second drive belt 20B is the same as the construction of the first drive belt 20A.

As shown in FIG. 1 and FIG. 3, the second drive mechanism 40 comprises a sprocket gear 41; this sprocket gear 41 is arranged so as to mesh simultaneously with the step chain 1 in the region la where the step chain 1 is proceeding along the outgoing path and with the step chain 1 in the region 1b where the step chain 1 is proceeding along the return path. In order to make this meshing possible, part of the guide rail 6 that guides the step chain 1 is cut away (see FIG. 3). It would be possible for meshing by the sprocket gear 41 to take place at only one or the other of the region 1a where the step chain 1 is proceeding along the outgoing path and the region 1b where the step chain 1 is proceeding along the return path. The rotary shaft 41a of the sprocket gear 41 is fixed at a suitable location of the main frame, not shown.

A drive pulley (drive roller) 42 is additionally provided on the sprocket gear 41, coaxially therewith. The second drive belt 20B is engaged with this drive pulley 42. The second drive belt 20B is pressed onto the drive pulley 42 by a pressing roller 43 that is biased by a spring 43a, so that reliable transmission of drive force from the drive roller 42 to the second drive belt 20B is thereby effected.

Consequently, when the steps 2 are driven by the motor 4, the second drive mechanism 40 drives the second drive belt 20B by extracting motive force from the step chain 1 and the handrail 10 that contacts the second drive belt 20B is thereby driven. The second drive mechanism 40 also drives the second drive belt 20B with a speed equal to the speed of movement of the steps 2.

The member indicated in FIG. 1 by the reference symbol 7 is part of an auxiliary step chain drive mechanism provided in the inclined movement zone of the steps 2; its detailed construction is disclosed in the Laid-open International Patent Application No. WO00/63104 relating to an international patent application by the inventors of the present application. This member 7 has no direct relationship with the gist of the present invention, so a detailed description thereof is not given here. However, it is desirable to provide such an auxiliary step chain drive mechanism in cases where this passenger conveyor is an elevator of high lift or is a moving walkway of long distance of movement.

Next, a third drive belt drive mechanism 50 (hereinbelow referred to as a “third drive mechanism 50”) for the third drive belt 20C provided at the upper level side will be described with reference solely to FIG. 1. The construction of the third drive belt 20C is the same as the construction of the first drive belt 20A.

The third drive mechanism 50 comprises a drive pulley (drive roller) 51; this drive pulley 51 is additionally provided with a timing pulley 52 that is coaxial therewith; a timing pulley 53 is arranged coaxially therewith on the step sprocket gear 2b on the upper level side, which is rotated in the manner of a follower by the step chain 1, without being directly driven by the motor 4. A timing belt 54 spans the timing pulleys 52, 53. The third drive belt 20C is engaged with the drive pulley 51. The drive pulley 51 is pressed against the third drive belt 20C by means of a spring-biased pressing roller 55, so that drive force transmission from the drive pulley 51 to the third drive belt 20C is reliably effected thereby. The timing pulleys 52, 53 are integral, constituting a drive device.

Consequently, when the steps 2 are driven by the motor 4, the third drive belt drive mechanism 50 drives the third drive belt 20C by extracting motive force from the shaft of the step sprocket gear 2b and the handrail belt 10 that contacts the second drive belt 20C is thereby driven. The third drive mechanism 50 also drives the third drive belt 20C with a speed that is equal to the speed of movement of the steps 2.

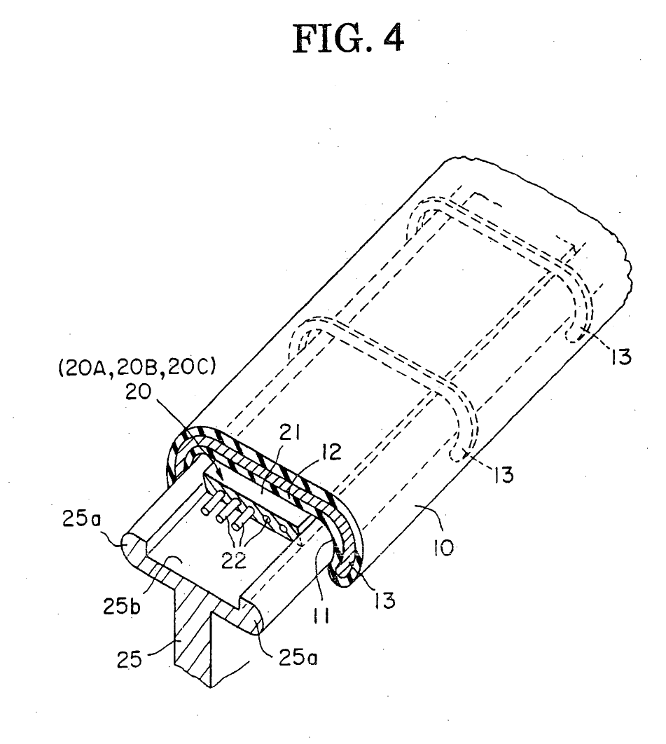

Next, drive force transmission from the drive belts 20 (20A, 20B, 20C) to the handrail belt 10 will be described with reference to FIG. 4. FIG. 4 is a perspective view including a cross-sectional view along the line IV-IV in FIG. 1. Although the designation “IV-IV” is provided at a plurality of locations in FIG. 1, the constructions at this plurality of locations are mutually substantially the same.

In FIG. 4, the reference symbol 25 is a guide rail for the drive belts 20, described above, and is also a guide rail for the handrails 10. The guide rail 25 is roughly of T-shaped cross-section. The guide rail 25 comprises a pair of projections 25a that extend in the horizontal direction. The handrail belt 10 that is employed in this embodiment is of roughly C-shaped cross-section like the handrail belt that is typically employed in a conventional passenger conveyor. The handrail belt 10 is guided by fitting in of the projections 25a into a recess 11 of the handrail belt 10. It should be noted that the projections 25a are provided only in the zone where the handrail belt 10 runs parallel with the drive belts 20 and are not provided in the other zones (for example the region where the guide rail 25 enters the interior of the railing 5, at the ends thereof).

Also, a groove 25b that receives the drive belts 20 is formed in the upper surface of the guide rail 25. As shown in FIG. 4, the drive belts 20 are flat belts (rectangular belts of thin cross-section). Preferably, means is provided in the groove 25b to reduce the frictional force acting between this and the drive belts 20. As such means, a low-friction resin coating layer provided at the surface of the groove 25b or rollers etc provided within the groove 25b may be employed.

The efficiency of drive force transmission from the drive belts 20 to the handrail belt 10 depends on the efficiency of meshing (this may also be referred to as the frictional force) between the drive belts 20 and the handrail belt 10 and the pressing force acting mutually between the handrail belt 10 and the drive belts 20.

In order to improve the meshing efficiency referred to above, a soft layer 12 may be provided on at least the surface of the handrail belt 10 that contacts the drive belts 20. In the embodiment shown in FIG. 2, the handrail belt 10 comprises a core member 13 and a soft layer 12 that covers the periphery of this core member 13. In contrast, the drive belts 20 comprise a roughened surface 21, for example a surface that is formed with surface irregularities. The roughened surface 21 meshes with the soft layer 12 of the handrail belt 10 and drive force transmission between these two is thereby reliably performed.

The core member 13 prevents the handrail belt 10 from slipping off the guide rail 25 by maintaining the C-shaped cross-sectional shape of the handrail belt 10. In order not to impair flexibility of the handrail belt 10, a plurality of core members 13 may be provided at prescribed intervals in the length direction.

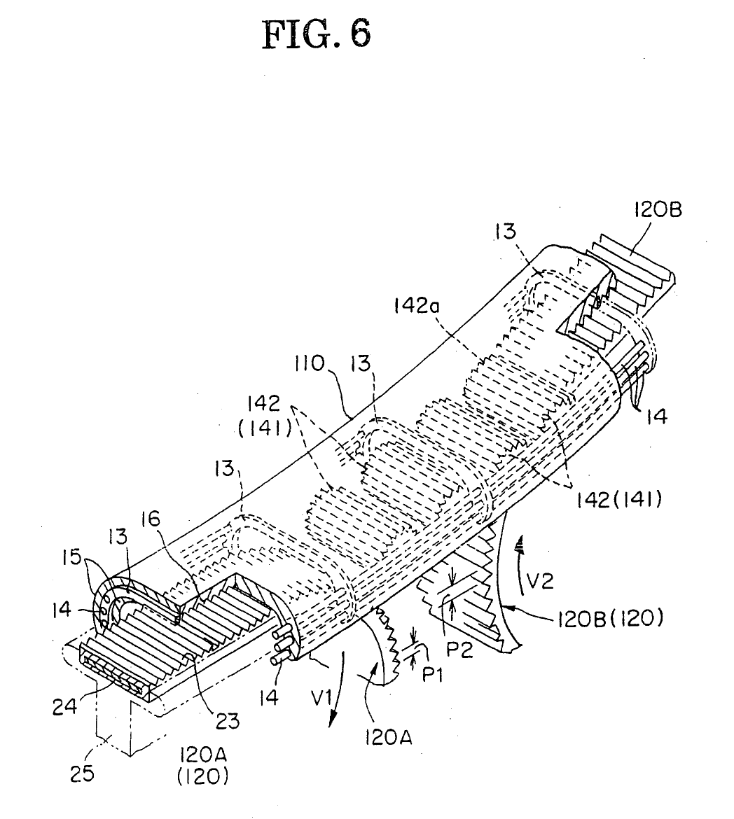

It should be noted that, in order to improve the meshing efficiency between the handrail belt 10 and the drive belts 20, a construction as shown in FIG. 6, that describes the second embodiment, may be employed (this will be described later).

Also, a plurality of sling wires 22, that is to say, a plurality of reinforcement wires 22 may be provided in the interior of the drive belts 20, the strength of the drive belts 20 in the length direction thereof being maintained by means of these reinforcements wires 22. There is therefore no possibility of the drive belts 20 being broken or elongated by application of load to the driving belts 20, for example by passengers gripping the handrail belt 10.

In this embodiment, the driving belts 20 are arranged to contact the handrail belt 10 within the range where the passengers can grip the handrail belt 10, so the pressing force acting between the driving belts 20 and the handrail belt 10 is considerably dependent on the force whereby the handrail belt 10 is pressed towards the driving belts 20 by the passengers gripping the handrail belt 10. This is very convenient in that it implies that the more passengers grip the handrail belt 10, the more the drive force transmission efficiency from the drive belt 20 to the handrail belt 10 is improved.

In addition, the pressing force that acts between the drive belts 20 and the handrail belt 10 depends on the tension acting in the handrail belt 10 itself (in particular in the region where the handrail belt 10 is folded back), in addition to the weight of the handrail belt 10 (in particular in the region where the handrail belt 10 can be gripped by the passengers). It is therefore desirable that means (a unit) should be provided to apply tension to the handrail belt 10 so that drive force transmission from the drive belts 20 to the handrail belt 10 is reliably achieved, even when no passenger is gripping the handrail belt 10. Such means (the unit) to apply tension may be means to apply tension such as is provided in a conventional handrail belt drive device.

However, the tension that is applied to the handrail belt may be considerably smaller than conventionally. Consequently, the load on the handrail belt 10 is only slight.

It should be noted that support rollers 8 that support and guide the handrail belt 10 may be provided in zones 6 where the guide rail 25 is interrupted. The support rail 8 may also be replaced by a guide rail of suitable shape. Also, suitable guide rollers or pulleys, not shown, may be provided at least in a zone 9B of the main frame, not shown, where the handrail belt 10 is bent. Also, as described above, a tensioner roller (not shown) could be provided that applies tension to the handrail belt 10 in the vicinity of the zone 9B in the case where means (a unit) for applying tension to the handrail belt 10 is provided, such as is provided in a conventional handrail belt drive device.

The following beneficial effects are obtained with this embodiment.

In the case where a conventional handrail belt drive device is employed, the handrail belt is required to have, simultaneously, mechanical strength capable of withstanding high loads and also a “feeling of quality” or “texture” (i.e. a pleasant sensation when touched by passengers and good appearance etc); it is difficult to satisfy these demands simultaneously. However, in this embodiment, it is sufficient for the drive belts 20 to have high mechanical strength; the mechanical strength of the handrail belt 10 in the length direction can be low. The handrail belt 10 can therefore be designed giving priority to this “feeling of quality”. It should be noted that maintenance of the cross-sectional shape of the handrail belt 10 can easily be achieved without sacrificing the feeling of quality for example by providing a core member 13 as shown in FIG. 2.

Also, since for the drive belts 20, flat belts of simple shape can be employed, forming is easy. Also, since it is sufficient if strength of the drive belts 20 in the length direction can be substantially guaranteed, guaranteeing the strength is easy. Furthermore, the pulleys (rollers) with which the drive belt 20 is engaged need only be of simple shape.

Also, since the overall shape of the handrail belt 10 can be made the same as the conventionally employed shape, passengers experience no feeling of disconformity and the same level of safety as conventionally can be ensured.

Also, since the handrail belt 10 and the drive belts 20 are constituted so as not to slip relative to each other, the same level of safety as conventionally can be ensured, with no slippage of the handrail belt 10 in the event of an emergency stop.

Also, since the width and the thickness of the drive belts 20 can be made smaller than that of the handrail belt 10, it is easy to secure sufficient space for the circulatory movement of the drive belts 20 through the interior of the railing 5.

Also, since the drive force of the drive belts 20 is extracted from the drive mechanism for driving the steps 2, synchronization of the speed of movement of the steps 2 and the drive speed of the handrail belt 10 can easily be achieved. Also, since the drive force of the drive belts 20 is extracted from members (step sprocket gears 2a, 2b, step chain 1) that are arranged near to the drive belt 20 that is to be driven, the respective drive mechanisms 30, 40, 50 can be constructed in a compact fashion.

Also, since drive force is transmitted to the handrail belt 10 from the drive belts 20 at a plurality of locations, excessive load can be prevented from being applied to a single drive belt. Also, however long the total length of the handrail belt 10, this can be coped with by increasing the number of drive belts 20.

It should be noted that, although, in the embodiment described above, drive of the handrail belt 10 was performed solely by means of the drive belts 20, there is no restriction to this. Specifically, the passenger conveyor may comprise a handrail belt drive device of the conventional type; in this case, the drive belts 20 constructed in accordance with the present invention and the drive mechanisms 30, 40, 50 thereof may be employed as auxiliary additional handrail belt drive mechanisms to supplement the handrail belt drive devices of the conventional type. In this case, only one of the drive belts and drive belt drive mechanisms constructed in accordance with the present invention need be provided for a single passenger conveyor.

Also, although in the above embodiment, the plurality of drive mechanisms 30, 40, 50 respectively had separate individual constructions, there is no restriction to this and at least two drive belt drive mechanisms of the plurality of drive belt drive mechanisms could have the same construction.

### Second Embodiment

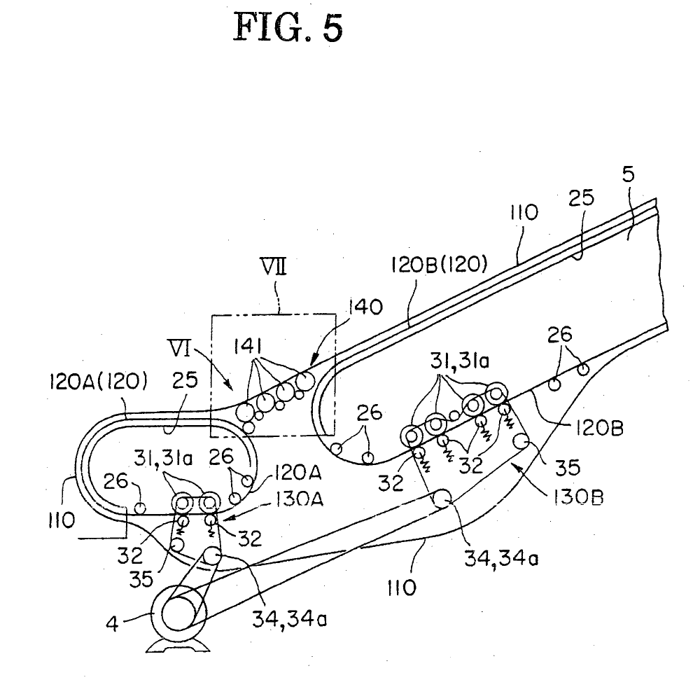

Next, a second embodiment will be described with reference to FIG. 5 to FIG. 8. This second embodiment relates to drive of a handrail belt that can be applied to a passenger conveyor called an “intermediate acceleration type” conveyor, in which the step speed in an intermediate region (inclined region of the steps) is greater than the step speed in the vicinity of the ascending/descending entrance/exit. In the second embodiment, members that are the same as in the case of the first embodiment are given the same reference symbols and duplicated description thereof is dispensed with. As the mechanism for implementing the intermediate acceleration of the steps, for example a construction as disclosed in pages 45-48 of Collected Lectures of the Advanced Technology Lecture Association and Recent Techniques in Elevators and Amusement Equipment, the Japan Society of Mechanical Engineering [No. 01-58]), mentioned in the section of this specification entitled “Technical background” could be employed; since the construction of the step drive mechanism itself has no direct relevance to the gist of the present invention, description thereof is dispensed with.

In such an intermediate acceleration type passenger conveyor, a step chain such as is typically employed in passenger conveyors is not employed, so, in this embodiment, drive force for the drive belt drive mechanism is extracted directly from the motor 4 that constitutes part of the step drive mechanism. However, a dedicated motor for handrail drive could be separately provided, separately from the motor 4 for step drive.

In this case, the motor for driving the step drive mechanism is termed the first motor, while the motor for driving the handrail drive mechanism is termed the second motor.

In this embodiment, there are provided a handrail drive belt 120A (120) i.e. a drive belt 120A that drives the handrail belt 110 in the vicinity of the lower-level ascending/descending entrance/exit and a handrail drive belt 120B (120) i.e. a drive belt 120B that drives the handrail belt 110 in the middle region. The drive belt 120B is guided so as to advance to a location somewhat in advance of the upper level ascending/descending entrance/exit, not shown, where it is folded back and returns to the lower level. The drive belts 120A, 120B are driven by drive belt drive mechanisms 130A, 130B (hereinbelow referred to as “drive mechanisms 130A, 130B”) having roughly the same construction as the first drive mechanism 30 described with reference to FIG. 1 and FIG. 2 above. The drive belt 120A is driven with a speed V1 while the drive belt 120B is driven with a speed V2 greater than the speed V1. Such a difference in speed between the drive belts can be achieved by suitably setting the diameters of the wheels such as the roller sprocket gear and timing pulley provided in the drive mechanisms 130A, 130B.

Since the drive belts 120A, 120B are driven with respective speeds V1, V2, the handrail belt 110 to which drive force is transmitted from these drive belts 120A, B is moved with a speed V1 in the vicinity of the ascending/descending entrance/exit (doorway) and is moved with a speed V2 in the intermediate region. The handrail belt 110 can therefore be elastically elongated by (1−V2/V1)×100% at least in the length direction. It should be noted that the reason that the handrail belt 110 is formed so as to be capable of elongation/contraction in this way is because a large strength is not required in the length direction of the handrail belt 110 itself, as explained in the paragraph describing the beneficial effect of the first embodiment.

The inventors of the present application discovered that long life can be anticipated if
0.9≦K≦1.2

where K(V1−V2)/V1=1−V2/V1.

This is because life is important if this handrail belt 110 is to be of practical use. Even though the breaking elongation is 500 to 650% in the case of natural rubber, in order to achieve reversible elongation/contraction, is necessary to perform chemical processing such as admixture of sulfur, in order to introduce bonding points so that the molecules do not become separated from each other. The foregoing is supported by experimental results.

The inventors of the present application conducted experiments on materials capable of elongation/contraction, using the following materials.

| Rubber | | | |
|---|---|---|---|
| material | Breaking | | |
| (abbreviation) | elongation % | Applications | Formal name |
| SBR | 100˜800 | Tires, shoes, | Styrene |
| | | other general | butadiene |
| | | applications | rubber |
| IR | 300˜1000 | Tires, shoes, | Isoprene |
| | | other general | rubber |
| | | applications | |
| BR | 200˜800 | Tires, other | Butadiene |
| | | general | rubber |
| | | applications | |
| EPR | 400˜800 | Industrial | Ethylene |
| | | uses, general | propylene |
| | | | rubber |
| IIR | 400˜800 | Electrical | Butyl rubber |
| | | cables, tire | |
| | | inner tubes | |
| T | 200˜700 | Oil-resistant | Polysulfide |
| | | applications | rubber |

Urethane fibers etc are employed as a stretch materials (commonly used for example in sportswear); although use of fibers confers extensibility/contractibility, complete reversibility tends not to be achieved, so it is necessary to ensure that fiber material introduced into the rubber material of the handrail belt 110 is not stretched any more than necessary.

As shown in FIG. 6, the handrail belt 110 has a cross-sectional shape that is roughly C-shaped, like the handrail belts that are typically employed. As in the case of the first embodiment, the handrail belt 110 has a plurality of core members 13 that are arranged at equal intervals in the length direction of the handrail belt 110.

Adjacent core members 13 are linked by means of extending/contracting slings 14 that allow the necessary elastic elongation of the handrail belt 110 in the length direction and that serve to prevent excessive elongation of the handrail belt 110. The core members 13 and extending/contracting slings 14 are embedded in a covering layer 15 formed of elastic material.

In this embodiment, there is a speed difference between the drive belts 120A, 120B, so, in order to prevent slippage between the handrail belt 110 and the drive belts 120A, 120B, even higher drive force transmission efficiency between the handrail belt 110 and the drive belts 120, in other words, reliable meshing, between the handrail belt 110 and the drive belts 120 is required. For this purpose, respectively complementary tooth grooves 16 and tooth grooves 23 are provided in the mutually contacting inner peripheral surface of handrail belt 110 and outer peripheral surface of drive belts 120. These two grooves 16, 23 apart from a triangular hill and valley shape, as shown, could be made of a concave/convex shape such as is formed in the surface of the timing belt, or could be made of a shape like the tooth grooves of a gearwheel.

In addition, the core members 13 are exposed from the covering layer 15 at the inner peripheral surface of the handrail belt 110, so as to mesh with the valleys of the tooth grooves 23 of the drive belt 120. In FIG. 6, it will be noted that the shape of the region of the tooth grooves 23 of the drive belt 120 that mesh with the core members 13 (i.e. the rectangular grooves) is formed to be different from the shape of the other regions (i.e. triangular grooves). In this way, the core members 13 mesh securely with the drive belt 120, improving drive force transmission efficiency. It would also be possible to make all of the tooth grooves 23 of the drive belt 120 of the same shape (for example to make them all of triangular shape) and to make the tips of the core members 13 of the same shape as the shape of the grooves of the tooth grooves 23 of the drive belts 120.

Rectangular grooves have the advantage that, when elongated, the rubber is securely held in position therein (i.e. such grooves are resistant to excess load).

Also, triangular grooves have the advantage that they can easily be separated from the drive belts 120. This is important in view of the risk that, if the handrail belt 110 stays engaged with the drive belts 120 without separating therefrom, mutual entrainment of the belts may occur, causing problems such as noise.

Another possible shape of the grooves is trapezoidal shaped grooves.

The meshing construction of the handrail belt 110 and drive belts 120 shown in FIG. 6 could of course be applied also in the first embodiment.

Steel bands 24 may be embedded within the drive belts 120 in order to increase the strength and rigidity in the length direction thereof. These steel bands 24 may replace the reinforcement slings 22 in the first embodiment. It should be noted that the drive belts 120 shown in FIG. 6 differ from the drive belts 20 shown in FIG. 4 only in respect of their surface shape (tooth grooves 23) and reinforcement members (the steel bands 24).

Also, from the point of view of protecting the handrail belt 110, it is preferable to prevent loading of the handrail belt 110 by local load, where the handrail belt 110 shifts from the drive belt 120A to the drive belt 120B. For this purpose, speed change means (speed change unit) 140 is provided to gradually change the speed of the handrail belt 110 from V1 to V2.

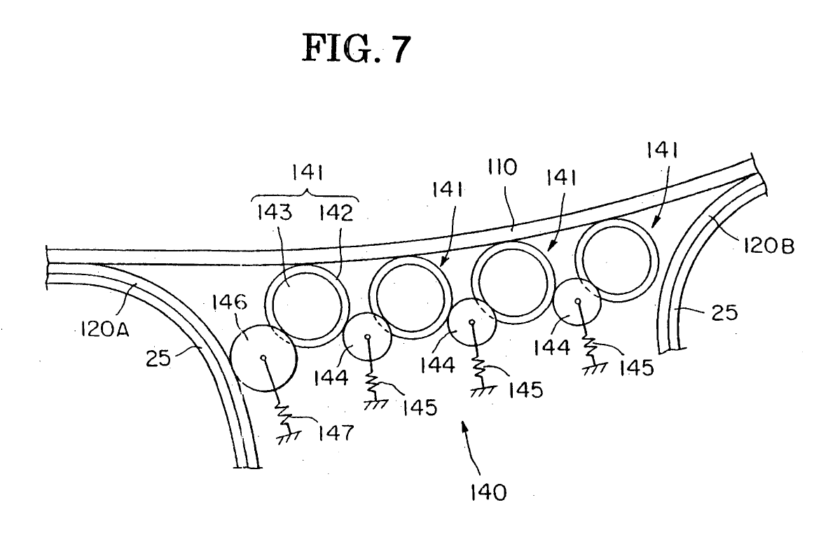

This speed change means (speed change unit) 140 is described in detail below with reference to FIG. 6 and FIG. 7. In FIG. 6, in order to simplify the drawing, the members indicated by the reference symbols 143, 145 and 147 in FIG. 7 are not shown.

In particular as shown in detail in FIG. 7, the speed change means (speed change unit) 140 comprises a plurality of sets of rollers 141, each set of rollers 141 comprising relatively larger-diameter large rollers 142 and relatively smaller-diameter small rollers 143 that are coaxially arranged. Tooth grooves 142a (only shown in FIG. 6) that can mesh with the tooth grooves 16 formed on the inner peripheral surface of the handrail belt 110 are provided at the outer peripheral surface of the large rollers 142.

Transmission rollers 144 are engaged with the large rollers 142 of the set of rollers 141 on the side near to the drive belt 120A and with the small rollers 143 of the set of rollers 141 that are adjacent on the side near to the drive belt 120B with this set of rollers 141. In order to achieve reliable motive force transmission between the large rollers 142 and small rollers 143 through the transmission rollers 144, the transmission rollers 144 are pressed against the large rollers 142 and small rollers 143 by means of springs 145.

Transmission rollers 146 are engaged with the small rollers 143 of the set of rollers 141 that is closest to the drive belt 120A. These transmission rollers 146 are simultaneously engaged with the drive belt 120A. In order to achieve reliable extraction of drive force from the drive belt 120A by means of the transmission rollers 146 and transmission of motive force to the small rollers 143, the transmission rollers 146 are pressed against the drive belt 128 and the small rollers 143 by means of springs 147.

The surfaces of the small rollers 143, the transmission rollers 144 and the transmission rollers 146 can be made smooth. In this case, the surfaces of the transmission rollers 144 and 146 are preferably formed by soft material so that reliable drive force transmission can be performed between the members (drive belt 128 and large rollers 142) that engage with these with concavities/convexities in the surface thereof. However, by providing tooth grooves in the surface of the small rollers 143, transmission rollers 144 and transmission rollers 146, it is also possible to perform drive force transmission from the drive belt 120A to the transmission rollers 146 and drive force transmission between the rollers 143, 142, 144 and 145 utilizing meshing of adjacent tooth grooves.

As can be understood from the above description, the peripheral speed of the large rollers 142 becomes progressively larger, the nearer these large rollers 142 are to the drive belt 120B. Also, the diameters of the transmission rollers 146, the large rollers 142 and small rollers 143 are set so that the peripheral speed of the large rollers 142 of the set of rollers 141 that is closest to the drive belt 120A is rather larger than the peripheral speed of the drive belt 120A and the peripheral speed of the large rollers 142 of the set of rollers 141 that is closest to the drive belt 120B is smaller than the speed of the drive belt 120B.

Consequently, the speed of the handrail belt 110 during separation from on the drive belt 120A and moving towards the drive belt 120B increases in stepwise fashion from V1 to V2 and, concurrently, the handrail belt 110 is progressively elongated. Since the handrail belt 110 is progressively elongated in this way, application of a large load locally to the handrail belt 110 can be prevented.

When the handrail belt 110 finally arrives over the drive belt 120B, it has been elongated by (1−V2/V1)×100%, with reference to when it was on the drive belt 120A. It then moves together with the drive belt 120B, maintaining this condition. In order to ensure reliable engagement between the tooth grooves 16 of the handrail belt 110 and the tooth grooves 24 of the drive belts 120A and 120B, the pitch of the tooth grooves 24 formed in the drive belt 120B is set to be V2/V1 times the pitch P1 of the tooth grooves 24 formed in the drive belt 120A.

Also, the pitch of the tooth grooves 142a formed in the large rollers 142 is set to be larger than the pitch P1 of the tooth grooves 24 of the drive belt 120A and smaller than the pitch P2 of the tooth grooves 24 of the drive belts 120B and, in the drive belt 120B, is set to be as large as the pitch of the tooth grooves 142a of the closest large rollers 142.

When the speed of the handrail belt is changed in this way, it is desirable that the passengers should be informed of this. The drive belts 120A and 120B are therefore colored. For example, the color of the drive belt 120B can be made red, which has connotations of high speed, the color of the drive belt 120A may be made yellow, which has connotations of a lower speed than this and the color of the large rollers 142 can be made orange, which is an intermediate color between these. Suitably, the color of the large rollers 142 can be made to be an orange that is progressively closer to yellow in the case of those rollers that are closest to the drive belt 120A and to be an orange that is progressively closer to red in the case of those rollers that are closest to the drive belt 120B. In this case, the handrail belt 110, in particular its covering layer 15 can be formed, in whole or in part (for example, the central portion in the width direction of the handrail belt 110), by transparent or semi-transparent material, so that passengers can recognize the color of the drive belts 120A, 120B and large rollers 142.

It should be noted that the colors of the drive belts 120A, 120B and large rollers 142 could be colors other than yellow, orange and red and are not restricted to chromatic colors but could be neutral colors. Also, the change in color produced by going from the drive belt 120A through the large rollers 142 to the drive belt 120B is not restricted to being a change of color as described above, but could be a change of lightness (brightness) or chromaticity.

Although in FIG. 5 only the construction of the region on the lower-level side of the passenger conveyor is illustrated, a drive belt identical with the drive belt 120A and a drive belt drive mechanism which is the same as the drive belt drive mechanism 130A are arranged also in the vicinity of the upper-level passenger ascending/descending entrance/exit (doorway). Also, speed change means that is identical with the speed change means (speed change unit) 140 is arranged between the upper-level drive belt drive mechanism and the middle drive belt drive mechanism 130B. In this way, the handrail belt 110 that moves with a speed V2 in the middle region is decelerated again to the speed V1 at the upper level ascending/descending entrance/exit (doorway).

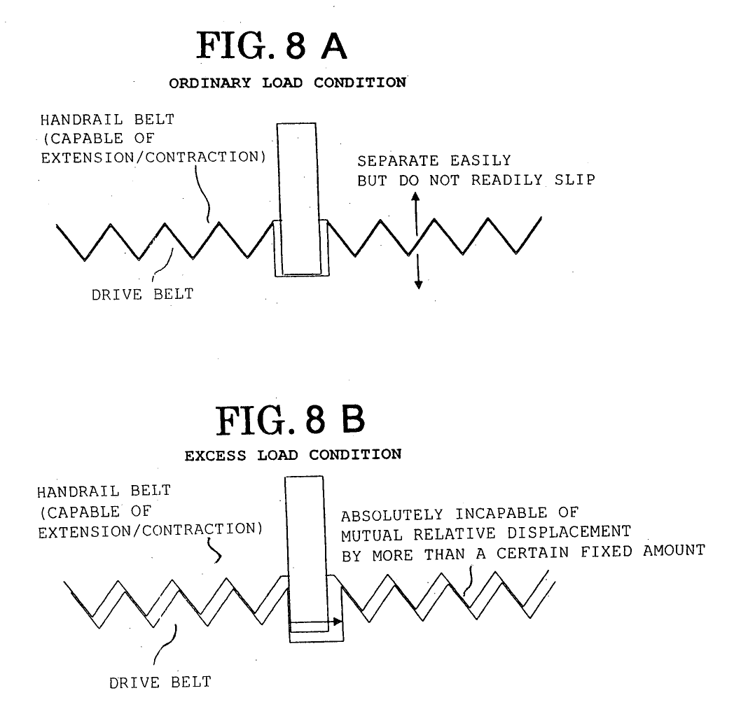

In addition, FIG. 8A and FIG. 8B are views showing the engaged condition of the handrail belt 110 and the drive belts 120. FIG. 8A shows the condition in which normal load is applied to both belts and FIG. 8B shows the condition in which excess load is applied to both belts.

### POSSIBILITY OF INDUSTRIAL APPLICATION

As will be clear from the above description, with a passenger conveyor according to the present invention, the load that is applied to the handrail belt of a passenger conveyor of a fixed speed type can be reduced.

Also, with a passenger conveyor according to the present invention, intermediate acceleration of the handrail belt can be implemented.

1. A passenger conveyor comprising:
a plurality of steps that are moved in circulatory fashion, being linked in endless fashion;
a step drive mechanism that drives said plurality of steps;
a railing provided at a side of said steps;
a handrail belt that moves in circulatory fashion in a prescribed circulatory path wound onto said railing;
a handrail drive belt that moves in circulatory fashion in a prescribed circulatory path and that transmits drive force for moving said handrail belt in circulatory fashion to said handrail belt by contacting an inner peripheral surface of said handrail belt; and
a drive belt drive mechanism that drives said handrail drive belt.

2. The passenger conveyor according to claim 1,
wherein a plurality of said handrail drive belts are provided and said plurality of handrail drive belts drive said handrail belt by contacting respective said handrail belt in mutually different regions in a circulatory path of said handrail belt.

3. The passenger conveyor according to claim 1,
wherein said handrail drive belt incorporates a steel band.

4. The passenger conveyor according to claim 1,
wherein said drive belt drive mechanism is constructed so as to extract drive force for driving said handrail drive belt from a member comprising said step drive mechanism.

5. The passenger conveyor according to claim 4,
further comprising
a step chain constituting part of said step drive mechanism, whereby said plurality of steps are linked in endless fashion and wherein said drive belt drive mechanism is arranged to extract drive force for driving said handrail drive belt from said step chain.

6. The passenger conveyor according to claim 4,
further comprising
a step chain constituting part of said step drive mechanism, whereby said plurality of steps are linked in endless fashion; and
a step sprocket gear constituting part of said step drive mechanism and whereon said step chain is wound;
wherein said drive belt drive mechanism is arranged to extract drive force for driving said handrail drive belt from a shaft of said step sprocket gear.

7. The passenger conveyor according to claim 4,
further comprising
a motor constituting part of said step drive mechanism and that generates drive force of said step drive mechanism,
wherein said drive belt drive mechanism is constructed so that said drive belt drive mechanism extracts drive force for driving said handrail belt from said motor.

8. The passenger conveyor according to claim 7,
wherein said motor comprises:
a first motor for driving said step drive mechanism; and
a second motor for driving said handrail drive mechanism.

9. The passenger conveyor according to claim 1,
wherein said handrail drive belt contacts said handrail belt at least in a range of the circulatory path of said handrail belt in which a passenger can touch the handrail belt.

10. The passenger conveyor according to claim 1,
wherein said drive belt drive mechanism comprises
a drive roller that transmits drive force to said handrail drive belt by contacting said handrail drive belt; and
a pressing roller that presses said handrail drive belt against said drive roller.

11. The passenger conveyor according to claim 1,
wherein a convex portion or convex concave portion is provided to improve drive force transmission efficiency to said handrail belt from said handrail drive belt, on at least one face meshing with the other of said handrail belt that makes contact with said handrail drive belt and a face of said handrail drive belt that makes contact with said handrail belt.

12. The passenger conveyor according to claim 1,
wherein said handrail belt has a roughly C-shaped cross-sectional shape.

13. The passenger conveyor according to claim 12,
wherein said handrail belt comprises a plurality of core members for maintaining a cross-sectional shape of said handrail belt, said plurality of core members being arranged at intervals along a length direction of said handrail belt.

14. The passenger conveyor according to claim 13,
wherein said core members are arranged so as to project from a face of said handrail belt that contacts said handrail drive belt, so as to mesh with said handrail drive belt.

15. The passenger conveyor according to claim 14,
wherein said meshing is of a hill/valley shaped triangular shape.

16. The passenger conveyor according to claim 14,
wherein said meshing is of concave/convex shape.

17. The passenger conveyor according to claim 14,
wherein said meshing is of tooth groove-shaped gearwheels.

18. The passenger conveyor according to claim 1,
wherein a plurality of said handrail drive belts, including a first handrail drive belt and a second handrail drive belt, are provided and a plurality of said drive belt drive mechanisms, including a first drive belt drive mechanism that drives said first handrail drive belt and a second drive belt drive mechanism that drives said second handrail drive belt, are provided, wherein said second drive belt drive mechanism drives said second drive belt with a speed that is greater than a speed with which said first drive belt drives said first drive belt drive belt, said handrail belt being capable of extension/contraction in a length direction thereof.

19. The passenger conveyor according to claim 13,
wherein said handrail belt comprises an elongation limiting member that defines an upper limit of an amount of elongation in a length direction thereof.

20. The passenger conveyor according to claim 18,
further comprising
at least one roller that applies drive force by contacting said handrail belt between a zone A where said first handrail drive belt contacts said handrail belt and a zone B where said second handrail drive belt contacts said handrail belt, wherein a peripheral speed of said roller is larger than a speed of said first handrail belt and smaller than a speed of said second handrail belt.

21. The passenger conveyor according to claim 20,
wherein a relationship of a tooth groove pitch P1 of said handrail drive belt in said zone A and a tooth groove pitch P2 of said handrail drive belt in said zone B is
P2/P1=V2/V1
where a speed in said zone A is V1 and a speed in said zone B is V2.

22. The passenger conveyor according to claim 20,
wherein if a speed in said zone A is V1 and a speed in said zone B is V2,
K=(V1−V2)/V1=1−V2/V1
where said K is
0.9≦K≦1.2

23. The passenger conveyor according to claim 20,
wherein a plurality of said rollers are provided, a peripheral speed of said rollers being progressively larger, the nearer said rollers are to said second handrail drive belt.

24. The passenger conveyor according to claim 20,
wherein a drive force for rotating said roller is extracted from said first handrail drive belt or said second handrail drive belt.

25. The passenger conveyor according to claim 20,
wherein said first handrail drive belt is colored with a first color and said second handrail drive belt is colored with a second color and said at least one roller is colored with a color that is intermediate between said first color and said second color; and
said handrail belt is partially or wholly transparent or semi-transparent so that a passenger may visually recognize said first and second handrail drive belts and said at least one roller.

26. The passenger conveyor according to claim 25,
wherein a plurality of said rollers are provided and a peripheral speed of said rollers is greater, the nearer said rollers are to said second handrail drive belt; and a coloring of said plurality of rollers is arranged to change from a color close to said first color to a color close to said second color as said second handrail drive belt is approached from said first handrail drive belt.
